(19) United States
(12) Patent Application Publication
(10) Pub. No.: US 2011/0122252 A1
(43) Pub. Date: May 26, 2011

(54) DIGITAL IMAGE PROCESSING APPARATUS AND PHOTOGRAPHING METHOD OF DIGITAL IMAGE PROCESSING APPARATUS

(75) Inventors: Eun-ho Choi, Yongin-si (KR); Seon-ho Lee, Suwon-si (KR); Seung-yong Kim, Goyang-si (KR); Jang-hoo Yoo, Seoul (KR)

(73) Assignee: Samsung Electronics Co., Ltd., Suwon-si (KR)

(21) Appl. No.: 12/949,948

(22) Filed: Nov. 19, 2010

(30) Foreign Application Priority Data
Nov. 20, 2009 (KR) 10-2009-0112783

(51) Int. Cl. H04N 5/33

(52) U.S. Cl. 348/164; 348/E05.09

(57) ABSTRACT

A digital image processing apparatus including an infrared (IR) cut filter and a visible light cut filter that are arranged on an optical axis between a lens unit and an image sensor, and that are selectively retractable from the optical axis, a filter driver that drives the IR cut filter and the visible light cut filter, a first image information acquiring unit that acquires first image information transmitted through the IR cut filter, a second image information acquiring unit that acquires second image information transmitted through the visible light cut filter, and an image synthesizing unit that extracts a synthesized image from the first image information and the second image information, in a low-illumination mode.

### CROSS-REFERENCE TO RELATED PATENT APPLICATION

This application claims the priority benefit of Korean Patent Application No. 10-2009-0112783, filed on Nov. 20, 2009, in the Korean Intellectual Property Office, the disclosure of which is incorporated herein in its entirety by reference.

### BACKGROUND

1. Field of the Invention

Embodiments relate to a digital image processing apparatus and a photographing method of the digital image processing apparatus, and more particularly, to a digital image processing apparatus that takes a clear image under low illumination and a photographing method of the digital image processing apparatus.

2. Description of the Related Art

A digital image processing apparatus, including a cellular phone, a digital camcorder, or a personal digital assistant (PDA), in which a digital camera or a camera module is installed, is an apparatus for recording an image of a subject by using an image sensor such as a charge-coupled device (CCD) and a complementary metal-oxide semiconductor (CMOS) that converts light data emitted through a lens into an electrical signal.

Usually, under conditions of low illumination in which an amount of ambient light is insufficient, a shaking image may be taken by the digital image processing apparatus due to decrease in a shutter speed and increase in exposure duration.

### SUMMARY

Embodiments include a digital image processing apparatus and a photographing method of the digital image processing apparatus, by which a clear image may be obtained by capturing an infrared region together with visible light under low illumination.

According to an embodiment, a digital image processing apparatus includes: an infrared (IR) cut filter and a visible light cut filter that are arranged on an optical axis between a lens unit and an image sensor, and that are each selectively retractable from the optical axis; a filter driver that drives the IR cut filter and the visible light cut filter; a first image information acquiring unit that acquires first image information transmitted through the IR cut filter; a second image information acquiring unit that acquires second image information transmitted through the visible light cut filter; and an image synthesizing unit that extracts a synthesized image from the first image information and the second image information, in a low-illumination mode.

The first image information acquiring unit may extract color data from the first image information.

The color data may include red (R), green (G) and blue (B) data.

The second image information acquiring unit may extract edge data of a subject from the second image information.

The edge data may include contrast data.

The image synthesizing unit may extract a synthesized image having contrast greater than contrast of the first image information and the second image information.

The image synthesizing unit may extract a synthesized image having color data that is closer to color data of an image in a reference illumination than color data of the first image information and the second image information.

The digital image processing apparatus may further include an illumination detecting unit that detects illumination of ambient light.

When the illumination of ambient light detected by the illumination detecting unit is equal to or smaller than a predetermined threshold value, the filter driver may drive the IR cut filter and the visible light cut filter so that the IR cut filter and the visible light cut filter are selectively and sequentially arranged on the optical axis.

According to another embodiment, a photographing method of a digital image processing apparatus that includes an infrared (IR) cut filter and a visible light cut filter that are arranged on an optical axis between a lens unit and an image sensor, and that are selectively retractable from the optical axis includes: arranging the IR cut filter on the optical axis, and acquiring first image information transmitted through the IR cut filter; arranging the visible light cut filter on the optical axis, and acquiring second image information transmitted through the visible light cut filter; and extracting a synthesized image from the first image information and the second image information, in a low-illumination mode.

The method may further include extracting color data from the first image information.

The color data may include red (R), green (G) and blue (B) data.

The method may further include extracting edge data from the second image information.

The edge data may include contrast data.

The synthesized image may be extracted so as to have contrast greater than contrast of the first image information and the second image information.

The synthesized image may be extracted so as to have color data that is closer to color data of an image in a reference illumination than color data of the first image information and the second image information.

When illumination of ambient light is equal to or smaller than a predetermined threshold value, the low-illumination mode may be automatically performed.

The IR cut filter and the visible light cut filter may be sequentially and selectively driven by a single driving system.

### BRIEF DESCRIPTION OF THE DRAWINGS

The above and other features and advantages will become more apparent by describing in detail exemplary embodiments with reference to the attached drawings in which:

FIG. 1 is a perspective view of a digital camera, according to an embodiment;

FIG. 2 is a rear view of the digital camera of FIG. 1, according to an embodiment;

FIG. 3 is a block diagram of a digital image processing apparatus, according to an embodiment;

FIGS. 4A, 4B, and 4C illustrate a first image, a second image and a third image that are captured under low illumination, according to embodiments; and

FIG. 5 is a flowchart of a photographing method of a digital image processing apparatus, according to an embodiment.

### DETAILED DESCRIPTION

Exemplary embodiments will now be described more fully with reference to the accompanying drawings.

According to various embodiments, a digital image processing apparatus may include a digital camera, and may be used in various image processing apparatuses such as a cellular phone, a digital camcorder, and a personal digital assistant (PDA), in which a digital camera or a camera module is installed. In this specification, a digital camera is exemplified. In addition, a single lens reflex (SLR) camera as well as a compact digital camera shown in the diagrams may be used.

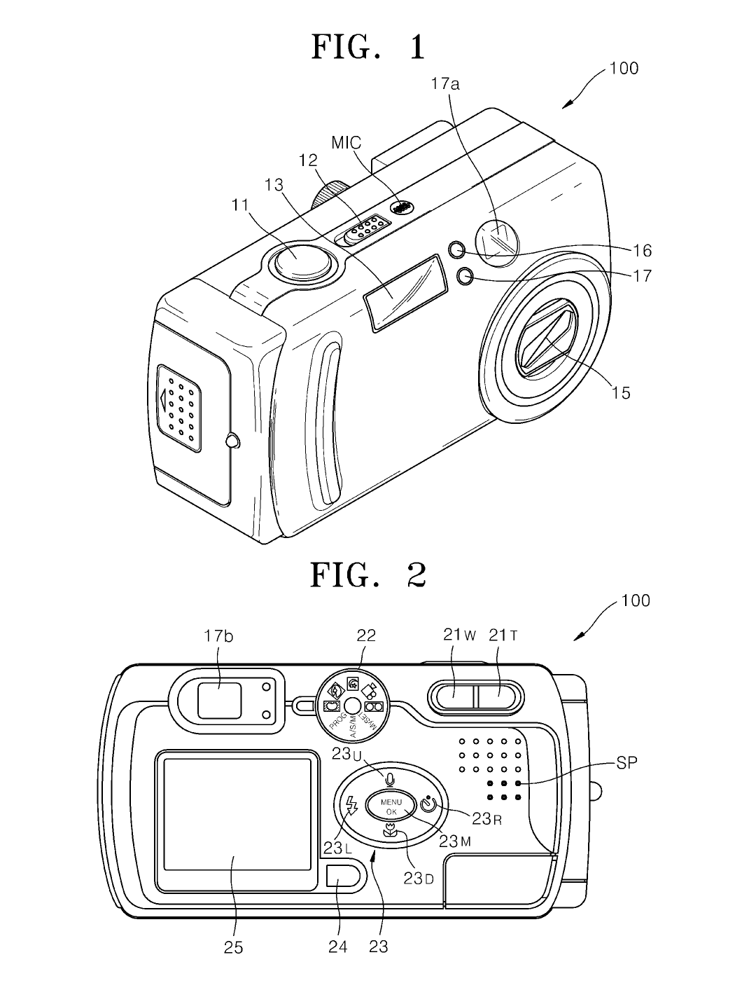

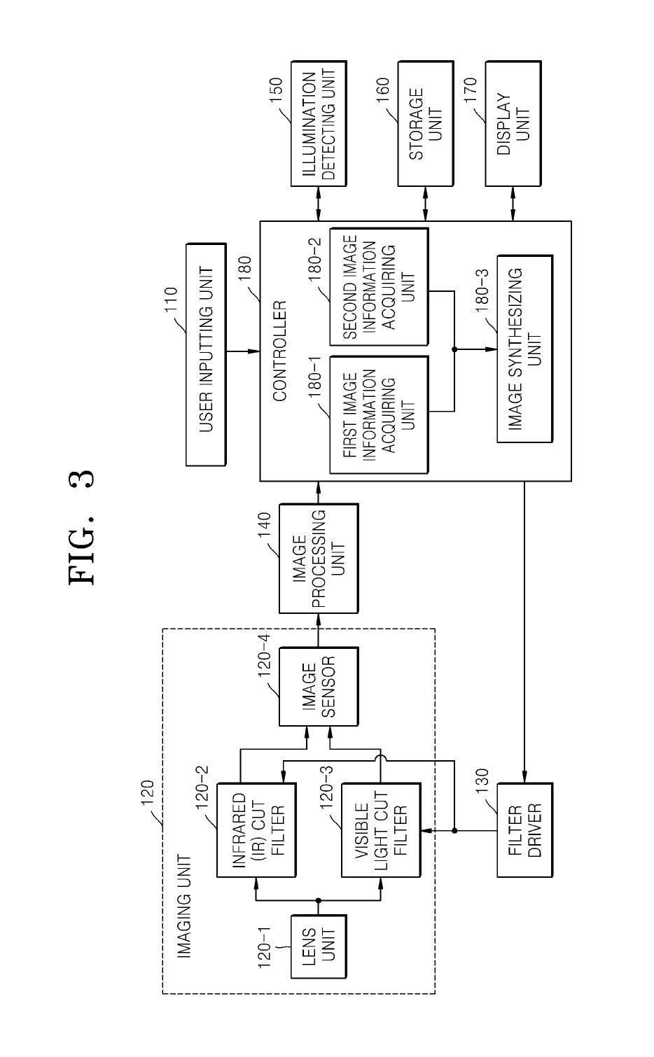

FIG. 1 is a perspective view of a digital camera 100, according to an embodiment. FIG. 2 is a rear view of the digital camera of FIG. 1, according to an embodiment.

The digital camera 100 captures an image and generates and stores an image file. The digital camera 100 includes a shutter-release button 11, a power button 12, a flash 13, a microphone (MIC), a view finder 17a, a lens unit 15, a flash-light amount sensor 16, and a light emitting diode (LED) lamp 17.

The shutter-release button 11 opens or closes a shutter in order to expose an image sensor such as a charge-coupled device (CCD) or a complementary metal-oxide semiconductor (CMOS) to light for a predetermined period of time. When the shutter-release button 11 is pressed, the digital camera 100 appropriately exposes a subject using an aperture (not shown) so as to record an image on the image sensor. The shutter-release button 11 generates first and second image photographing signals by a user's input. When the shutter-release button 11 is pressed halfway in order to input a half-shutter signal, the digital camera 100 focuses on the subject, and adjusts an amount of light. When the digital camera 100 is focused on the subject, a green light appears on a display unit 25. When the digital camera 100 focuses on the subject and adjusts an amount of light by the pressing of the shutter-release button 11 halfway in order to input the half-shutter signal, an image of the subject is captured by fully pressing the shutter-release button 11 in order to input a full-shutter signal.

The power button 12 is pressed in order to supply power and to operate the digital camera 100.

The flash 13 is used in photographing and instantly emits light to illuminate dark surroundings. A flash mode may include auto flash, forced flash, flash-off, red-eye reduction, and slow synchronization (sync).

When the flash 13 operates, the flash-light amount sensor 16 detects an amount of light, and inputs information regarding the amount of light to a digital camera processor (not shown) via a microcontroller (not shown).

The lens unit 15 receives light from an external light source, and optically processes the image of the subject. Although not illustrated in FIG. 1, the lens unit 15 may include a zoom lens, a focus lens, and a compensation lens.

The LED lamp 17 provides light to the subject so that the digital camera 100 may quickly and correctly focus on the subject when natural lighting is inadequate or photography is performed at nighttime.

Referring to FIG. 2, the digital camera 100 includes a view finder 17b, a wide angle-zoom button 21w, a telephoto-zoom button 21t, a mode dial 22, a function button 23, a playback mode button 24, a speaker SP, and the display unit 25.

The wide angle-zoom button 21w and the telephoto-zoom button 21t are used to widen and narrow a viewing angle according to the input of the wide angle-zoom button 21w and the telephoto-zoom button 21t. In particular, the wide angle-zoom button 21w and the telephoto-zoom button 21t may be used to change a size of a selected exposed area. In this case, the size of the selected exposed area is reduced by pressing the wide angle-zoom button 21w, and the size of the selected exposed area is increased by pressing the telephoto-zoom button 21t.

The mode dial 22 is used to select any one operational mode from among operational modes of the digital camera 100, for example, a simple photography mode, a program photography mode, a human photography mode, a night view photography mode, an inactive photography mode, a moving-picture photography mode, a user setting mode, and a recording mode.

The function button 23 includes an up key 23U, a down key 23D, a left key 23L and a right key 23R. The function button 23 may be used to move an image during the playback of the image on the display unit 25, or may be used to move a direction of an activation cursor in a menu image displayed on the display unit 25. In addition, the function button 23 includes a menu button 23M to access various menus related to an operation of the digital camera 100. The above-listed keys may be used as shortened keys for performing predetermined functions.

The playback mode button 24 is used to switch between a playback mode and a preview mode.

The display unit 25 is used to display the image of the subject thereon. Thus, the user may view an image on the display unit 25 prior to photography, and may check the result of the photography after the photography. In addition, various manipulations required for the operation of the digital camera 100 may be performed through the display unit 25.

FIG. 3 is a block diagram of a digital image processing apparatus, according to an embodiment. The digital image processing apparatus according to the present embodiment includes a user inputting unit 110, an imaging unit 120, a filter driver 130, an image processing unit 140, an illumination detecting unit 150, a storage unit 160, a display unit 170, and a controller 180.

The user inputting unit 110 inputs a signal for controlling all operations of the digital camera 100 by a user's manipulation, and includes the shutter-release button 11 (hereinafter, see FIGS. 1 and 2), the power button 12, the wide angle-zoom button 21w, the telephoto-zoom button 21t, and the function button 23.

The imaging unit 120 converts an optical signal of an image of a subject into an electrical signal, and includes an optical system that includes a lens unit 120-1 and a filter unit (not shown) including an infrared (IR) cut filter 120-2 and a visible light cut filter 120-3, and an image sensor 120-4.

The lens unit 120-1 may include a zoom lens, a focus lens and a compensation lens.

The IR cut filter 120-2 has a cut-off frequency of a predetermined IR band of 630 nm or more. Thus, the IR cut filter 120-2 filters light beams incident on the lens unit 120-1 by blocking a light beam of an IR band from among the light beams and transmitting a light beam of a visible light beam from among the light beams. The IR cut filter 120-2 may appropriately block IR rays that are input together with visible rays and that may contribute to noise of an image.

The visible light cut filter 120-3 has a cut-off frequency of a predetermined visible light band (about 350 nm to about 600 nm). The visible light cut filter 120-3 blocks a light beam of a visible light band from among the light beams incident on the lens unit 120-1, and transmits a light beam of an IR band from among the light beams. Accordingly, the visible light cut filter 120-3 may be used in a case of special photography using an IR band or a case of photography under low illumination with almost no light.

In this case, locations of the IR cut filter 120-2 and the visible light cut filter 120-3 are not limited as long as the IR cut filter 120-2 and the visible light cut filter 120-3 are perpendicular to a path of a light beam transmitted through the lens unit 120-1 to the image sensor 120-4. However, in order to minimize a space occupied by the IR cut filter 120-2 and the visible light cut filter 120-3, the IR cut filter 120-2 and the visible light cut filter 120-3 may be disposed on the same plane. In this case, the IR cut filter 120-2 and the visible light cut filter 120-3 may be driven by a single driving system.

Although not illustrated in FIGS. 1 through 3, the digital camera 100 may further include various filters, apart from the IR cut filter 120-2 and the visible light cut filter 120-3. For example, an optical low pass filter (OLPF) (not shown) may prevent Moire fringe that may be formed by interference between subjects that are periodically arranged, and may transmit a light beam of a low band from among the light beams incident on the lens unit 120-1.

The filter driver 130 drives the IR cut filter 120-2 and the visible light cut filter 120-3. According to the present embodiment, in a case of photography under low illumination with almost no light, the filter driver 130 may drive the IR cut filter 120-2 and the visible light cut filter 120-3 so that the IR cut filter 120-2 and the visible light cut filter 120-3 may be sequentially or reversely arranged on an optical axis, and thus information of an image in which IR rays are blocked and information of an image in which visible light is blocked may be transferred to the image sensor 120-4 by sequentially or reversely arranging the IR cut filter 120-2 and the visible light cut filter 120-3 on an optical axis. The filter driver 130 may be a single driving system, and may drive the IR cut filter 120-2 and the visible light cut filter 120-3.

In a case of photography in a non-low illumination mode, or according to a user's selection, the filter driver 130 may drive the IR cut filter 120-2 and the visible light cut filter 120-3 so that only one of the IR cut filter 120-2 and the visible light cut filter 120-3 is disposed on an optical axis in a single photography operation, and thus a visible light photography mode or an IR photography mode may be performed.

The illumination detecting unit 150 detects the amount of ambient light. When the amount of ambient light is equal to or smaller than a predetermined threshold value, that is, under a low-illumination, the filter driver 130 may drive the IR cut filter 120-2 and the visible light cut filter 120-3 so that the IR cut filter 120-2 and the visible light cut filter 120-3 may be sequentially and selectively arranged on the optical axis.

The image sensor 120-4, such as a CCD or a CMOS, accumulates an amount of light incident through the lens unit 120-1, the IR cut filter 120-2, and the visible light cut filter 120-3, and outputs an image captured by the lens unit 120-1 in synchronization with a vertical synchronization signal, according to the accumulated amount of light. An image capture of the digital camera 100 is performed by the image sensor 120-4 such as a CCD for converting light reflected from an object into an electrical signal. In order to obtain a color image by using the image sensor 120-4, a color filter (not shown) is used. Mostly, the color filter may include a color filter array (CFA). The CFA has a structure in which only a light beam exhibiting a single color is transmitted through each pixel and pixels are regularly arranged, and is of various types according to the pixel arrangement.

An analog image signal output from the image sensor 120-4 is converted into a digital image signal by an analog-to-digital (A/D) converter (not shown), and the digital image signal corresponds to RAW data of a captured image file.

The image processing unit 140 performs signal processing so as to display the digitized RAW data, and removes Black level due to a dark current generated in a CCD and a CFA that are sensitive to a temperature change. The image processing unit 140 performs gamma-correction for encoding information according to the non-linearity of human eyesight, and performs CFA interpolation for interpolating, to RGB lines, Bayer fringe realized in RGRG and GBGB lines of predetermined data on which the gamma correction is performed. In addition, the image processing unit 140 performs edge-compensation for converting interpolated RGB signals into YUV signals and filtering a Y signal to clear an image with a high band pass filter, and generates an image file such as a joint photographic experts group (JPEG) file by correcting color values of U and V signals and removing noise by using a standard color coordinates system, and performing compression and signal processing on Y, U and V signals from which noise is removed.

In this case, first image information may be generated by removing noise from image data transmitted through the IR cut filter 120-2, and second image information may be generated by providing clear edge information to image data transmitted through the visible light cut filter 120-3. A synthesized image file such as a JPEG file may be generated by synthesizing the first image information and the second image information and performing compression and signal processing on the synthesized first image information and second image information.

The generated image file or synthesized image file may be stored in the storage unit 160, such as a memory card, according to the user's settings, and may be displayed on the display unit 170.

The storage unit 160 is used to lastly store the image file or the synthesized image file, and may include various-standardized memory cards such as a smart card, a compact flash (CF) memory, a memory stick, and a secure digital (SD) memory card. It will be understood by one of ordinary skill in the art that the storage unit 160 may further include an electrically erasable and programmable read-only memory (EEPROM) for storing algorithms required for operations of a digital camera processor, and a flash memory for storing set data required for the operations of the digital camera processor, in addition to the memory cards for storing the above-described image files.

The operations of the digital camera 100 are controlled by the controller 180. The controller 180 includes a first image information acquiring unit 180-1, a second image information acquiring unit 180-2, and an image synthesizing unit 180-3.

The first image information acquiring unit 180-1 acquires color data, for example, red, green and blue data, from information of a first image ‘I₁’, which is transmitted through the IR cut filter 120-2 and from which noise is removed.

The second image information acquiring unit 180-2 acquires edge data, for example, contrast data, from information of a second image ‘I₂’, which is transmitted through the visible light cut filter 120-3.

The image synthesizing unit 180-3 extracts information of the first image ‘I₁’ and information of the second image ‘I₂’ and synthesizes the first image ‘I₁’ and the second image ‘I₂’ into a third image ‘I₃’ in a low-illumination mode. In this case, the contrast of information of the synthesized third image ‘I₃’ is greater than that of the information of the first image ‘I₁’ and the information of the second image ‘I₂’. In a case of a general digital camera including an IR cut filter, although noise may be removed from an image, when an amount of ambient light is insufficient, a shaking image may be taken due to increase in an exposure duration or decrease in a shutter speed. However, according to the present embodiment, in a case of low-illumination photography, the image synthesizing unit 180-3 may synthesize the third image ‘I₃’ by using color data acquired from the information of the first image ‘I₁’, which is transmitted through the IR cut filter 120-2 and from which noise is removed, and the contrast data acquired from the information of the second image ‘I₂’, which is transmitted through the visible light cut filter 120-3 so as to compensate for an unclear edge, thereby acquiring the synthesized third image ‘I₃’ having a clear color and edge.

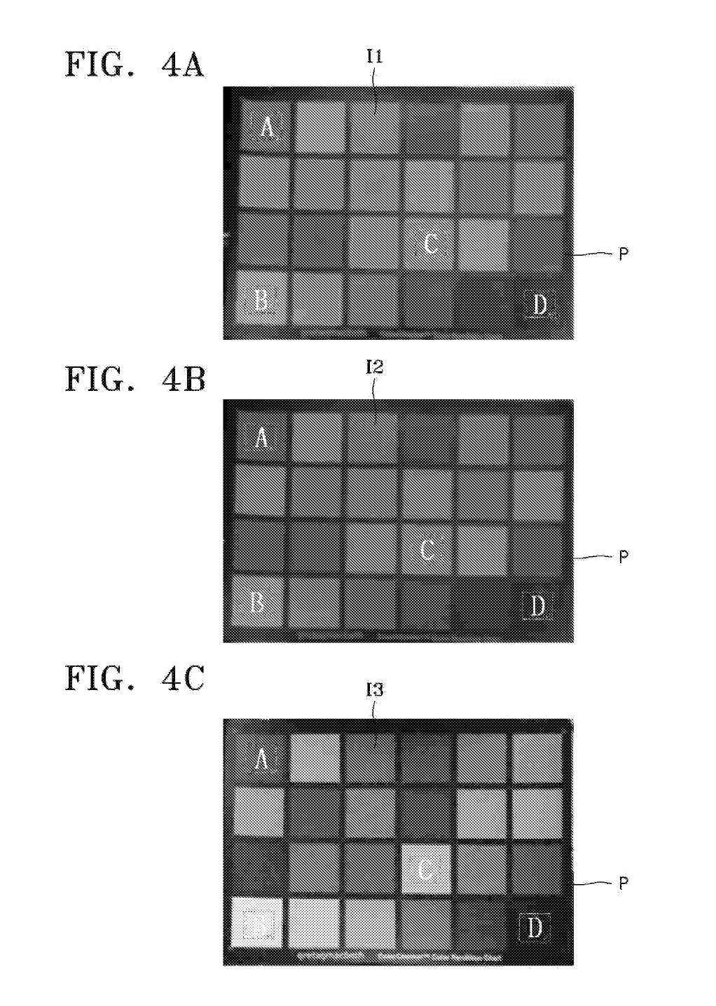

FIGS. 4A, 4B, and 4C illustrate a first image, a second image and a third image that are captured under low illumination, according to embodiments. FIG. 4A illustrates the first image ‘I₁’ of a pixel panel ‘P’, which is transmitted only through an IR cut filter, in a case of low-illumination photography, according to an embodiment. FIG. 4B is an image illustrating the second image ‘I₂’ of the pixel panel ‘P’, which is transmitted only through a visible light cut filter, in a case of low-illumination photography, according to an embodiment. FIG. 4C is an image illustrating the third image ‘I₃’ of the pixel panel ‘P’, which is acquired by synthesizing the information of the first image ‘I₁’ and the information of the second image ‘I₂’, in a case of low-illumination photography, according to an embodiment.

Table 1 below shows RGB data at four points A, B, C and D of the first image ‘I₁’, the second image ‘I₂’ and the third image ‘I₃’. Table 2 below shows contrast data of all of the first image ‘I₁’, the second image ‘I₂’ and the third image ‘I₃’, in a case of low-illumination photography. Table 3 below shows RGB data at four points A, B, C and D of a reference image ‘I₀’ captured under reference illumination.

TABLE 1

| | I₁ | I₂ | I₃ |
|---|---|---|---|
| A | 110.90.65 | 179.14.80 | 105.81.60 |
| B | 142.142.140 | 250.56.135 | 225.226.221 |
| C | 150.126.30 | 241.50.117 | 213.185.87 |
| D | 43.40.52 | 88.5.17 | 21.18.28 |

TABLE 2

| | I₁ | I₂ | I₃ |
|---|---|---|---|
| All | 101,886,885,174.9917 | 99,954,060,235.5752 | 142,794,819,442.3482 |
| im- | | | |
| ages | | | |

TABLE 3

| | I₀ |
|---|---|
| A | 107.85.62 |
| B | 231.233.226 |
| C | 225.209.30 |
| D | 30.31.33 |

In Tables 1 and 2, the RGB data and contrast data of the first image ‘I₁’, the second image ‘I₂’ and the third image ‘I₃’ are based on the surroundings having illumination of 1 Lux. In Table 3, the RGB data of the reference image ‘I₀’ is based on the surroundings having illumination of 50 Lux.

Referring to FIGS. 4A through 4C and Tables 1, 2 and 3, when an amount of ambient light is insufficient, the contrast of the third image ‘I₃’ is increased as compared to the contrast of the first image ‘I₁’ and the second image ‘I₂’. In addition, the color data of the third image ‘I₃’ is extracted to be closer to color data of the pixel pane ‘I’', which is obtainable in the reference illumination, than the color data of the first image ‘I₁’ and the second image ‘I₂’. Thus, an image having a clear color and edge may be obtained even under low illumination by extracting the third image ‘I₃’ obtained by synthesizing the information of the first image ‘I₁’ and the second image ‘I₂’, which are transmitted respectively through the IR cut filter 120-2 and the visible light cut filter 120-3.

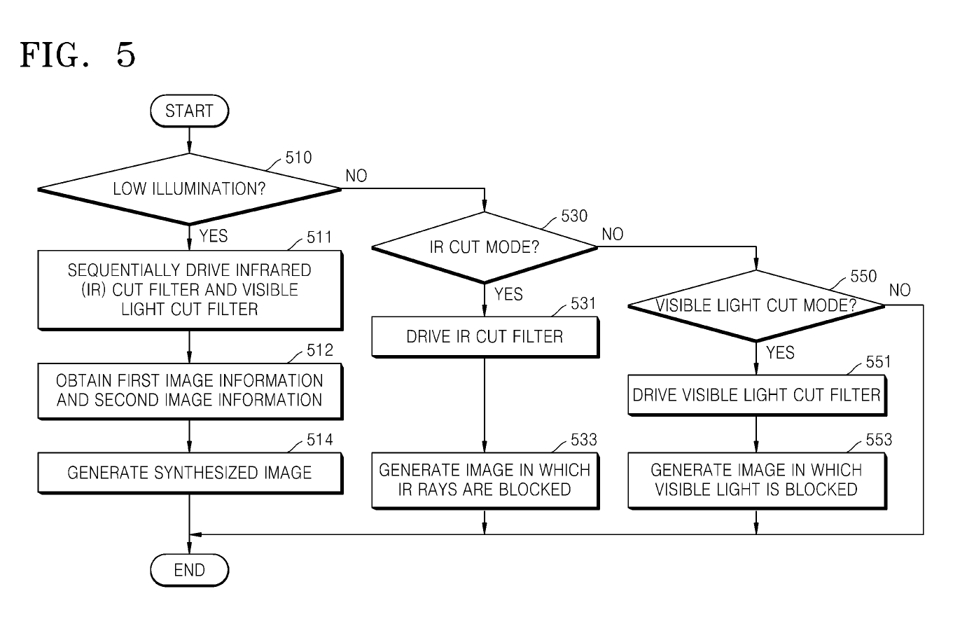

FIG. 5 is a flowchart of a photographing method of a digital image processing apparatus, according to an embodiment. Hereinafter, a photographing method of a digital image processing apparatus will be described with reference FIG. 5. The photographing method according the present embodiment may be performed in the digital imaging apparatus of FIG. 3. The main algorithms of the photographing method may be performed in the controller 180 with help of peripheral components thereof.

Referring to FIG. 5, when an amount of ambient light is insufficient, the digital image processing apparatus enters a low-illumination mode (Operation 510). In this case, the illumination detecting unit 150 detects the amount of ambient light. If the amount of ambient light is equal to or smaller than a predetermined threshold value, the digital image processing apparatus may automatically enter a low-illumination mode. It will be understood by one of ordinary skill in the art that a user may determine whether the amount of ambient light corresponds to low-illumination, and then the digital image processing apparatus may be controlled to compulsively enter the low-illumination mode.

In case of low-illumination, the filter driver 130 drives the IR cut filter 120-2 and the visible light cut filter 120-3 so that the IR cut filter 120-2 and the visible light cut filter 120-3 are sequentially or reversely arranged on an optical axis (Operation 511). IR rays that may contribute to noise of an image may be appropriately blocked from a light beam transmitted through the lens unit 120-1 and the IR cut filter 120-2, and then the light beam may be incident on the image sensor 120-4. Visible light may be blocked from a light beam transmitted through the lens unit 120-1 and the visible light cut filter 120-3, and then the light beam may be incident on the image sensor 120-4.

The first image information acquiring unit 180-1 acquires color data from information of a first image ‘I₁’, which is transmitted through the IR cut filter 120-2 and from which noise is removed, and the second image information acquiring unit 180-2 acquires edge data from information of a second image ‘I₂’, which is transmitted through the visible light cut filter 120-3 (Operation 512). In this case, red, green and blue data may be acquired as the color data, and contrast data may be acquired as the edge data.

Then, the image synthesizing unit 180-3 synthesizes the first image ‘I₁’ and the second image ‘I₂’ so as to generate the third image ‘I₃’ (Operation 514). As described above, the contrast of the synthesized third image ‘I₃’ is greater than that of the first image ‘I₁’ and the second image ‘I₂’. The color data of the third image ‘I₃’ is extracted to be closer to color data that is obtainable in the reference illumination, than the color data of the first image ‘I₁’ and the second image ‘I₂’. Thus, according to the present embodiment, an image having a clear color and edge may be obtained even under low illumination by extracting the third image ‘I₃’ obtained by synthesizing the information of the first image ‘I₁’ and the second image ‘I₂’, which are transmitted respectively through the IR cut filter 120-2 and the visible light cut filter 120-3.

Otherwise, in case of photography under non-low illumination mode (Operation 510), an IR cut mode (Operation 530) and a visible light cut mode (Operation 550) may be performed according to a user's selection.

In a case of the IR cut mode (Operation 530), the visible light cut filter 120-3 is retracted, and only the IR cut filter 120-2 is disposed on an optical axis (Operation 531). Since the IR cut filter 120-2 has a cut-off frequency of a predetermined IR band, the IR cut filter 120-2 generates an image having a clear color by appropriately blocking IR rays in a light beam incident on the lens unit 120-1 that may contribute to noise of the image (Operation 533).

In a case of the visible light cut mode (Operation 550), the IR cut filter 120-2 is retracted, and only the visible light cut filter 120-3 is disposed on the optical axis (Operation 551). Since the visible light cut filter 120-3 has a cut-off frequency of a predetermined visible light band, the visible light cut filter 120-3 generates an image in which visible light in a light beam incident on the lens unit 120-1 is blocked (Operation 553). The visible light cut mode may be used in a case of special photography using an IR band or a case of photography under low illumination with almost no light.

According to the present embodiment, an image having a clear color and edge may be obtained even under low illumination by extracting the third image ‘I₃’ obtained by synthesizing the information of the first image ‘I₁’ and the second image ‘I₂’, which are transmitted respectively through the IR cut filter 120-2 and the visible light cut filter 120-3.

Since the digital image processing apparatus includes the IR cut filter 120-2 and the visible light cut filter 120-3 that are arranged on an optical axis between the lens unit 120-1 and the image sensor 120-4, and the filter driver 130 may drive the IR cut filter 120-2 and the visible light cut filter 120-3 so that the IR cut filter 120-2 and the visible light cut filter 120-3 may be selectively retractable, the IR cut mode and the visible light cut mode may be used without adding another separate device. Thus, in a case of the IR cut mode, an image having a clear color may be obtained by appropriately blocking IR rays that may contribute to noise of an image. In a case of the visible light cut mode, special photography using an IR band or photography under low illumination with almost no light may be performed.

According to the digital image processing apparatus, an image having a clear color and edge may be obtained even under low illumination by extracting a third image by synthesizing information of a first image and a second image that are transmitted respectively through an IR cut filter and a visible light cut filter.

In addition, since the digital imaging processing apparatus includes an IR cut filter and a visible light cut filter that are arrangeable on an optical axis between a lens unit and an image sensor, and a single filter driver drives the IR cut filter and the visible light cut filter so that the IR cut filter and the visible light cut filter are selectively retractable, an IR cut mode and a visible light cut mode may be used without adding another separate device.

The apparatus described herein may comprise a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media such as read-only memory (ROM), random-access memory (RAM), CD-ROMs, magnetic tapes, floppy disks, and optical data storage devices. The computer readable recording media may also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. The words “mechanism” and “element” are used broadly and are not limited to mechanical or physical embodiments, but may include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. It will be recognized that the terms “comprising,” “including,” and “having,” as used herein, are specifically intended to be read as open-ended terms of art.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention.

What is claimed is:

1. A digital image processing apparatus comprising:
an infrared (IR) cut filter and a visible light cut filter that are arranged on an optical axis between a lens unit and an image sensor, and that are each selectively retractable from the optical axis;
a filter driver that drives the IR cut filter and the visible light cut filter;
a first image information acquiring unit that acquires first image information transmitted through the IR cut filter;
a second image information acquiring unit that acquires second image information transmitted through the visible light cut filter; and
an image synthesizing unit that extracts a synthesized image from the first image information and the second image information, in a low-illumination mode.

2. The digital image processing apparatus of claim 1, wherein the first image information acquiring unit extracts color data from the first image information.

3. The digital image processing apparatus of claim 2, wherein the color data comprises red (R), green (G) and blue (B) data.

4. The digital image processing apparatus of claim 1, wherein the second image information acquiring unit extracts edge data of a subject from the second image information.

5. The digital image processing apparatus of claim 4, wherein the edge data comprise contrast data.

6. The digital image processing apparatus of claim 1, wherein the image synthesizing unit extracts a synthesized image having contrast greater than contrast of the first image information and the second image information.

7. The digital image processing apparatus of claim 1, wherein the image synthesizing unit extracts a synthesized image having color data that is closer to color data of an image in a reference illumination than color data of the first image information and the second image information.

8. The digital image processing apparatus of claim 1, further comprising an illumination detecting unit that detects illumination of ambient light.

9. The digital image processing apparatus of claim 8, wherein, when the illumination of ambient light detected by the illumination detecting unit is equal to or smaller than a predetermined threshold value, the filter driver drives the IR cut filter and the visible light cut filter so that the IR cut filter and the visible light cut filter are selectively and sequentially arranged on the optical axis.

10. A photographing method of a digital image processing apparatus comprising an infrared (IR) cut filter and a visible light cut filter that are arranged on an optical axis between a lens unit and an image sensor, and that are selectively retractable from the optical axis, the method comprising:
arranging the IR cut filter on the optical axis, and acquiring first image information transmitted through the IR cut filter;
arranging the visible light cut filter on the optical axis, and acquiring second image information transmitted through the visible light cut filter; and
extracting a synthesized image from the first image information and the second image information, in a low-illumination mode.

11. The method of claim 10, further comprising extracting color data from the first image information.

12. The method of claim 11, wherein the color data comprises red (R), green (G) and blue (B) data.

13. The method of claim 10, further comprising extracting edge data from the second image information.

14. The method of claim 13, wherein the edge data comprises contrast data.

15. The method of claim 10, wherein the synthesized image is extracted so as to have contrast greater than contrast of the first image information and the second image information.

16. The method of claim 10, wherein the synthesized image is extracted so as to have color data that is closer to color data of an image in a reference illumination than color data of the first image information and the second image information.

17. The method of claim 10, wherein, when illumination of ambient light is equal to or smaller than a predetermined threshold value, the low-illumination mode is automatically performed.

18. The method of claim 17, wherein the IR cut filter and the visible light cut filter are sequentially and selectively driven by a single driving system.
